(19) United States
(12) Patent Application Publication
(10) Pub. No.: US 2016/0188822 A1
(43) Pub. Date: Jun. 30, 2016

(54) CLINICAL DECISION SUPPORT RULE GENERATION AND MODIFICATION SYSTEM AND METHODS

(71) Applicant: CERNER INNOVATION, INC., Kansas City, KS (US)

(72) Inventors: Hugh H. Ryan, Lee's Summit, MO (US); Amanda Kathleen Sullins, Lee's Summit, MO (US); Donna J. Cappo, Independence, MO (US); Donald Joshua Dooley, Lee's Summit, MO (US)

(21) Appl. No.: 14/585,848

(22) Filed: Dec. 30, 2014

(51) Int. Cl. G06F 19/00

(52) U.S. Cl. CPC G06F 19/345; G06F 19/322

(57) ABSTRACT

Methods, systems, computer storage media, and graphical user interfaces for facilitating the creation and maintenance of one or more clinical decision support rules by a healthcare provider are disclosed. Rule segment options including pre-defined parameters may be provided to a healthcare provider for selection in order to facilitate the efficient creation and/or maintenance of one or more clinical decision support rules by a healthcare provider.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention generally relate to facilitating the creation and maintenance of clinical decision support rules by a healthcare provider to facilitate care for a population of patients. A clinical decision support rule may be utilized to alert one or more healthcare providers when to take action with respect to one or more patients and/or to identify patients within a population of patients that satisfy one or more clinical decision support rules.

Accordingly, in one aspect, an embodiment of the present invention is directed to one or more computer storage media storing computer-executable instructions that, when executed by one or more computing devices, cause the one or more computing devices to perform a method that facilitates the creation and maintenance of one or more clinical decision support rules by a healthcare provider. The method includes providing, to a healthcare provider, information for display on a computing device associated with the healthcare provider, the information including information associated with a plurality of rule segment options. The plurality of rule segment options can include a plurality of pre-defined parameters for use in the creation of one or more clinical decision support rules. The method further includes receiving, at a server, a selection of one or more rule segment options of the plurality of rule segment options, the one or more rule segment options defining at least a portion of a clinical decision support rule. The method also includes executing the clinical decision support rule in one or more EMRs associated with an EMR database to identify one or more patients that satisfy at least a portion of the clinical decision support rule. The method further includes providing, to the healthcare provider, information associated with the one or more patients that satisfy the clinical decision support rule, for display on a computing device associated with the healthcare provider.

In another aspect, an embodiment of the present invention is directed to a computer system that facilitates the creation and maintenance of one or more clinical decision support rules by a healthcare provider. The computer system includes a processor coupled to a computer storage medium, the computer storage medium having stored thereon a plurality of computer software components executable by the processor. The computer software components include a rule generation component configured to provide to a healthcare provider a plurality of rule segment options. The plurality of rule segment options include pre-defined parameters for use in the creation of at least one clinical decision support rule. The computer software components also include an accessing component configured to access one or more EMRs in a database of EMRs associated with a population of patients; and an execution component configured to execute the at least one clinical decision support rule in the one or more EMRs in a database of EMRs associated with a population of patients and configured to identify one or more patients within the population of patients that satisfy at least a portion of the at least one clinical decision support rule. The computer software components further include a display component configured to provide to the healthcare provider information for display on a computing device associated with the healthcare provider, the information for display including information associated with the one or more patients within the population of patients that satisfy the at least a portion of the at least one clinical decision support rule.

In yet another aspect, an embodiment of the present invention is directed to a computer-implemented method being performed by one or more computing devices including at least one processor, for facilitating the creation and maintenance of one or more clinical decision support rules by a healthcare provider. The method includes providing, to a healthcare provider, information for display on a computing device associated with the healthcare provider, the information including information associated with a plurality of rule segment options. The plurality of rule segment options can include pre-defined parameters for use in the creation of one or more clinical decision support rules. The method further includes receiving, at a server, a selection from the healthcare provider of one or more rule segment options of the plurality of rule segment options, the one or more rule segment options defining at least a portion of a clinical decision support rule. The method also includes receiving, at the server, a selection from the healthcare provider of one or more other healthcare providers to receive information associated with patients that satisfy the clinical decision support rule; and executing the clinical decision support rule in one or more EMRs in an EMR database associated with a population of patients to identify one or more patients within the population of patients that satisfy at least a portion of the clinical decision support rule. The method further includes providing, to the healthcare provider and the one or more other healthcare providers, information associated with the one or more patients, for display on one or more computing devices associated with the healthcare provider and one or more computing devices associated with the one or more other healthcare providers.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram of an exemplary clinical decision support rule generation and maintenance system, in accordance with embodiments of the present invention;

FIGS. 3-9 depict illustrative screen displays, in accordance with exemplary embodiments of the present invention;

FIG. 10 is a flow diagram illustrating an exemplary method that facilitates the creation and maintenance of one or more clinical decision support rules by a healthcare provider, in accordance with embodiments of the present invention; and

FIG. 11 is a flow diagram illustrating another exemplary method that facilitates the creation and maintenance of one or more clinical decision support rules by a healthcare provider, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Currently, in order to create, modify, and/or implement a clinical decision support rule an Information Technology (IT) specialist or a specialist associated with a particular medical records and/or health information system is usually needed to create, modify, and/or implement such a clinical decision support rule. Further, creating and implementing clinical decision support rules can be time consuming, resulting in such rules not being executed within a system in a timely manner. In addition, a more user-friendly process to create, modify, and/or implement clinical decision support rules is needed so that a healthcare provider can create, modify, and/or implement clinical decision support rules with little to no technical knowledge of a health information system, and without the aid of an IT specialist or a specialist associated with a particular medical records and/or health information system.

Accordingly, various aspects of the technology described herein are generally directed to methods, systems, computer storage media, and graphical user interfaces for facilitating the creation and/or maintenance of clinical decision support rules for use in a medical records system and/or a health information system. Various embodiments of the present invention are directed to facilitating the creation and maintenance of clinical decision support rules by a healthcare provider to allow for a healthcare provider to efficiently create, modify, and/or utilize clinical decision support rules for providing better healthcare to one or more patients within a population of patients. In embodiments, a clinical decision support rule generation and maintenance system can facilitate the creation, modification, and/or utilization of clinical decision support rules by one or more healthcare providers to generate worklists for one or more healthcare providers and/or for one or more healthcare facilities. In various embodiments, one or more healthcare providers can tailor a clinical decision support rule to be active for only specific healthcare providers and/or for only specific healthcare facilities.

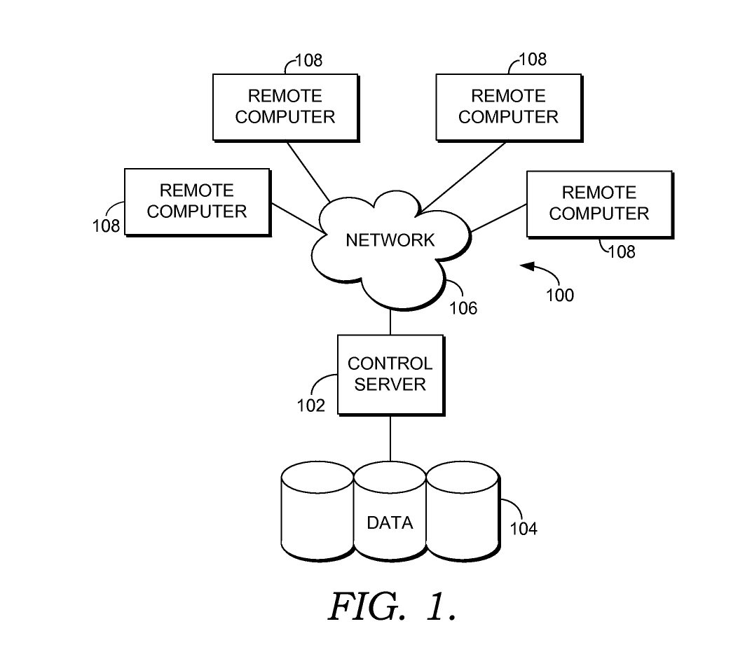

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment or at healthcare facilities, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians or healthcare providers may comprise a treating physician or physicians; specialists such as surgeons, radiologists, cardiologists, and oncologists; emergency medical technicians; physicians' assistants; nurse practitioners; health coaches; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization, a healthcare provider, and/or a user at a healthcare facility might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

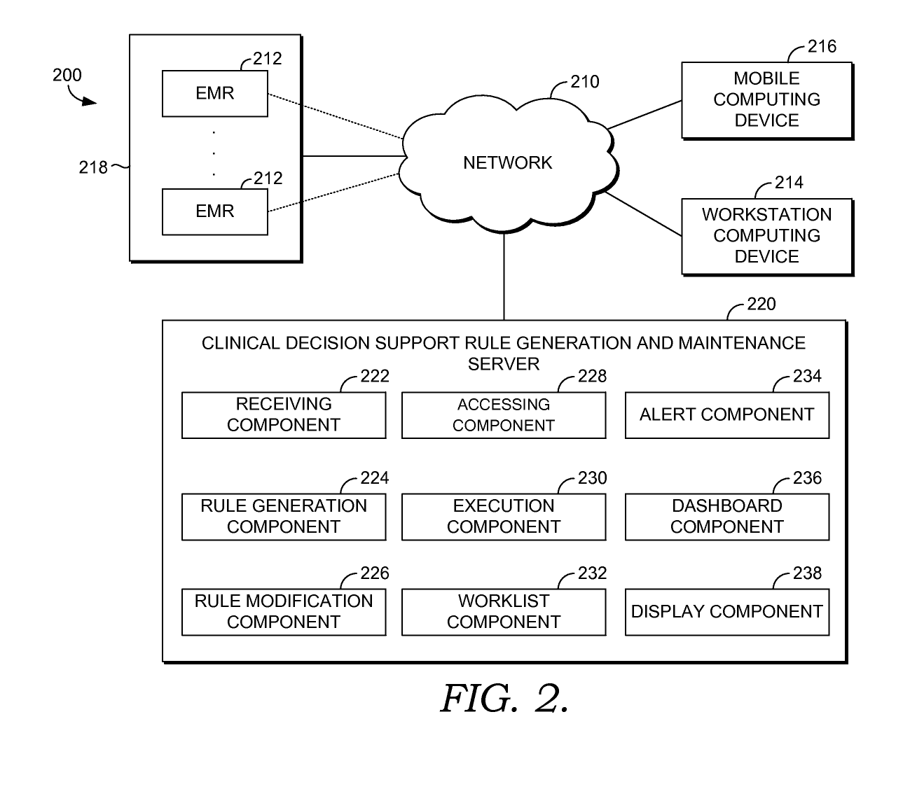

Turning now to FIG. 2, an exemplary clinical decision support rule generation and maintenance system 200 suitable for use in implementing embodiments of the present invention is depicted. The clinical decision support rule generation and maintenance system 200 is merely an example of one suitable computing system environment and is not intended to suggest any limitation as to the scope of use or functionality of embodiments of the present invention. Neither should the clinical decision support rule generation and maintenance system 200 be interpreted as having any dependency or requirement related to any single module/service/component or combination of modules/services/components illustrated therein.

The clinical decision support rule generation and maintenance system 200 may include: a clinical decision support rule generation and maintenance system server 220 (hereinafter referred to as the clinical decision support rule server 220); one or more electronic medical records 212 (EMRs) associated with an electronic medical record (EMR) database 218; a workstation computing device 214; a mobile computing device 216, such as a phone and/or a tablet, all in communication with each other through wired or wireless connections and/or through the network 210. The network 210 may include, without limitation, one or more local area networks (LANs) and/or wide area networks (WANs). Such networking environments are commonplace in offices, enterprise-wide computer networks, intranets and the Internet. Accordingly, the network is not further described herein.

In various embodiments, the workstation computing device 214 and/or the mobile computing device 216 can include any or all of the properties and parameters of the remote computers 108 discussed above with reference to FIG. 1.

In one or more embodiments, the EMR database 218 may include one or more data stores of healthcare records, such as the EMRs 212, which may include one or more computers or servers that facilitate the storing and retrieval of the healthcare records. In various embodiments, one or more EMRs 212 and/or the EMR database 218 may be implemented as a cloud-based platform or may be distributed across multiple physical locations.

Example embodiments of the EMRs 212 may include hospital, ambulatory, clinic, health exchange, and health plan records systems. The EMRs 212 may further include record systems, which store real-time or near real-time patient (or user) information, such as wearable, bedside, or in-home patient monitors, for example. It is further contemplated that embodiments of the EMRs 212 may use distinct clinical ontologies, nomenclatures, vocabularies, or encoding schemes for clinical information, or clinical terms. Further, in some embodiments, the EMRs 212 may be affiliated with two or more separate healthcare entities, healthcare venues, healthcare facilities, healthcare organizations, and/or healthcare communities that use two or more distinct nomenclatures.

In embodiments, the EMRs 212 may include electronic healthcare documents such as images, clinical notes, orders, summaries, reports, analyses, or other types of electronic medical documentation relevant to a particular patient's condition and/or treatment. Electronic healthcare documents may contain various types of information relevant to the condition and/or treatment of a particular patient and can include information relating to, for example, patient identification information, images, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

The clinical decision support rule server 220 of FIG. 2 is merely exemplary. While the clinical decision support rule server 220 of FIG. 2 is illustrated as a single unit, it will be appreciated that the clinical decision support rule server 220 may include one or more separate components, services, and/or modules. Further in embodiments, the clinical decision support rule server 220 may be scalable. For example, the clinical decision support rule server 220 may in actuality include a plurality of computing devices in communication with one another. Components of the clinical decision support rule server 220 may include a processing unit, internal system memory, and a suitable system bus for coupling various system components, including one or more data stores for storing information (e.g., files and metadata associated therewith). In embodiments, each of these components, services, and/or modules typically includes, or has access to, a variety of computer-readable media.

In some embodiments, one or more of the illustrated components of the clinical decision support rule server 220 may be implemented as one or more stand-alone applications. Further, various components, services, and/or modules may be located on any number of servers. By way of example only, the clinical decision support rule server 220 may reside on a server, cluster of servers, a cloud-computing device or distributed computing architecture, or a computing device remote from one or more of the remaining components. In certain embodiments, one or more components, services, and/or modules of the clinical decision support rule server 220 may reside in one or more of the workstation computing device 214 or the mobile computing device 216, such as a laptop computer, phone, and/or a tablet. In the same or alternative embodiments, one or more components, services, and/or modules of the clinical decision support rule server 220 may reside in one or more servers, cluster of servers, cloud-computing devices or distributed computing architecture, or a computing device remote from or more of the workstation computing device 214 or the mobile computing device 216.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components and/or modules, and in any suitable combination and location. Various functions described herein as being performed by one or more entities may be carried out by hardware, firmware, and/or software. For instance, various functions described herein with reference to the clinical decision support rule server 220 may be carried out by a processor executing instructions stored in memory.

As discussed above, the clinical decision support rule server 220 may comprise one or more components, services, and/or modules. For example, as depicted in FIG. 2, the clinical decision support rule server 220 may include a receiving component 222, a rule generation component 224, a rule modification component 226, an accessing component 228, an execution component 230, a worklist component 232, an alert component 234, a dashboard component 236, and a display component 238. In certain embodiments, one or more of the components 222, 224, 226, 228, 230, 232, 234, 236, or 238 may be configured to provide or convey information that can populate a graphical user interface, which may be viewed on a device, such as one or more of the workstation computing device 214 or the mobile computing device 216.

In one or more embodiments, one or more of the components 222, 224, 226, 228, 230, 232, 234, 236, or 238 may be implemented as stand-alone applications. In other embodiments, one or more of the components 222, 224, 226, 228, 230, 232, 234, 236, or 238 may be integrated directly into the operating system of a computing device, such as the remote computer 108 of FIG. 1 and/or one or more of the workstation computing device 214 or the mobile computing device 216 of FIG. 2. It will be understood that the components 222, 224, 226, 228, 230, 232, 234, 236, and 238 illustrated in FIG. 2 are exemplary in nature and in number and should not be construed as limiting. Any number of components and/or modules may be employed to achieve the desired functionality within the scope of embodiments described herein.

In certain embodiments, the receiving component 222 is configured to receive a request from a healthcare provider to modify and/or generate a clinical decision support rule. In such embodiments, the request may be received via a computing device associated with the healthcare provider, e.g., the workstation computing device 214 or the mobile computing device 216.

In embodiments, the rule generation component 224 is configured to provide to a healthcare provider one or more rule segment options. In certain embodiments, the rule segment options include pre-defined parameters for use in the creation of a clinical decision support rule. In such embodiments, the pre-defined parameters can include one or more of medical treatments, medical treatment status, medications, amounts and/or duration of medications, patient vital sign information, patient demographics information, clinical laboratory tests, results and/or ranges for clinical laboratory tests, time periods, or Boolean operators.

The rule generation component 224 can provide rule segment options and/or pre-defined parameters to a healthcare provider in any manner known to one skilled in the art as long as the healthcare provider is able to select rule segment portions to define at least a portion of a clinical decision support rule. For example, in one or more embodiments, the rule generation component 224 can provide to a healthcare provider one or more lists of medication options, one or more lists of medication status options, one or more lists of routes of the medication options, one or more lists of dosage form options, and one or more lists of dosage frequency options. In such embodiments, the healthcare provider may select particular items from any or all of such lists in the process of generating at least a portion of a clinical decision support rule, such as generating at least one level of a clinical decision support rule.

In one or more embodiments, the rule generation component 224 may provide to the healthcare provider categories for selection that correspond to the type of clinical decision support rule being generated. In such embodiments, the categories may include, but are not limited to, microbiology, medications, clinical laboratory tests, vital signs, demographics, and other orders. Further, in such embodiments, by selecting a category to associate with the type of clinical decision support rule being generated, the rule generation component 224 may be prompted to identify and provide a sub-set of pre-defined parameters for the healthcare provider to choose from, thus making lists of pre-defined parameters easier to navigate compared to providing all pre-defined parameters irrespective of the rule category.

In certain embodiments, by selecting a category to associate with the type of clinical decision support rule being generated, the rule generation component 224 may be prompted to provide a list of healthcare facilities and/or healthcare providers to the healthcare provider so that the healthcare provider can select which facilities and/or providers will receive information generated from the execution of the clinical decision support rule. For example, in certain embodiments, if a healthcare provider is creating a clinical decision support rule related to anticoagulation, that healthcare provider does not need any information generated from the execution of that clinical decision support rule, such as an alert, being provided to a Rheumatologist. In embodiments, the list of healthcare facilities and/or healthcare providers may be pre-defined by the rule generation component 224 as relating to the selected category, or the rule generation component 224 may select pre-programmed healthcare facilities and/or healthcare providers that are to receive information associated with that category of clinical decision support rule. In alternative embodiments, the selection of a category associated with the clinical decision support rule being generated need not prompt the rule generation component 224 to provide a list of healthcare providers and/or healthcare facilities for selection; rather, the list of healthcare providers and/or healthcare facilities for selection can be provided to the healthcare provider whether or not a category has been selected.

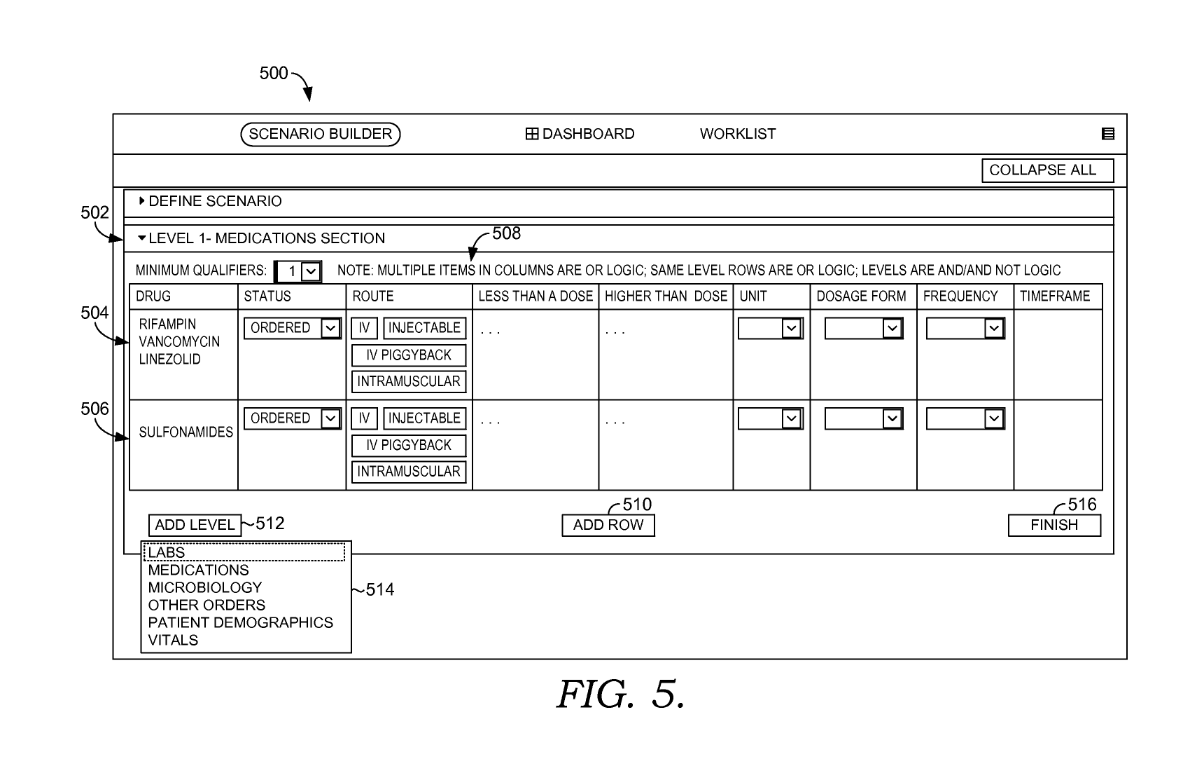

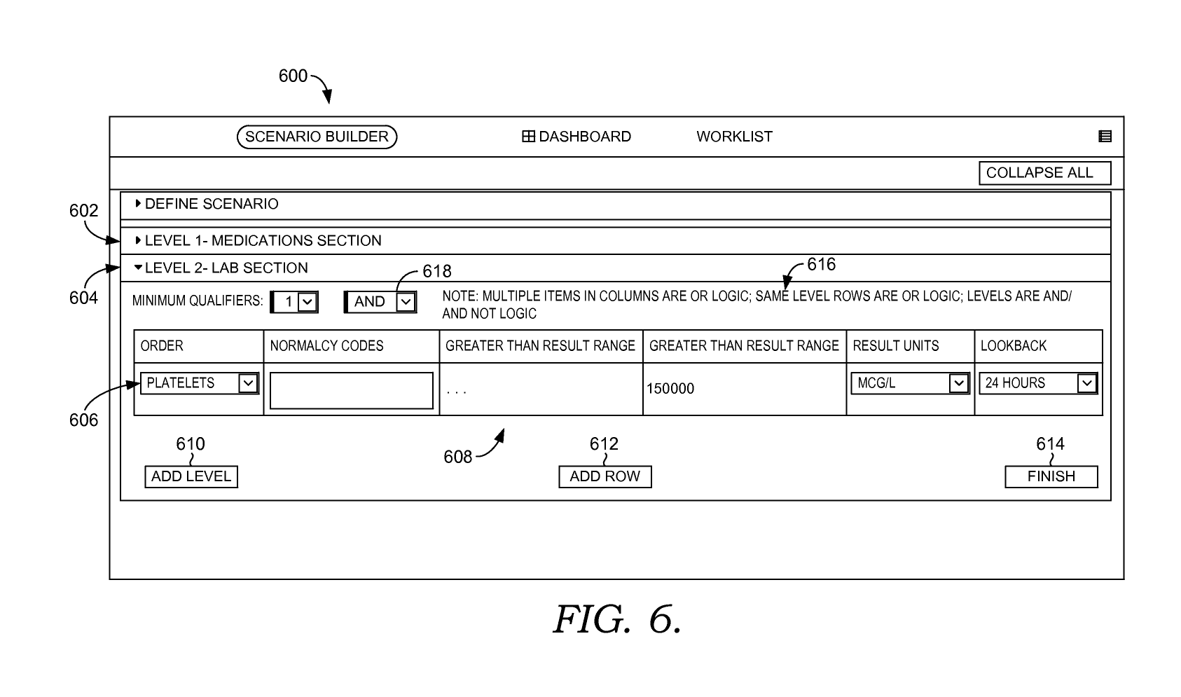

In embodiments, as discussed below with reference to FIGS. 5 and 6, the healthcare provider can generate a plurality of levels of a clinical decision support rule, where each level may be linked together by one or more Boolean operators, e.g., AND, OR, ANDNOT, etc. For example, in one embodiment, the healthcare provider can generate one portion of a clinical decision support rule, e.g., a level relating to a clinical laboratory test, in addition to another portion of a clinical decision support rule, e.g, another level, relating to medications. In such embodiments, the rule generation component 224 may also provide a list of Boolean operators, e.g., AND, OR, ANDNOT, etc., so that the healthcare provider can select how each portion and/or level (e.g., the level relating to medications and the level relating to clinical laboratory tests) should be utilized in the clinical decision support rule.

In embodiments, the rule segment options, the pre-defined parameters, and/or the Boolean operators may be provided to the healthcare provider in the form of drop-down lists or in any other format that can provide efficient access to such options. In embodiments, by providing to a healthcare provider these pre-defined lists that are easily accessible, the healthcare provider can easily and efficiently create at least a portion of the clinical decision support rule without having to identify the appropriate nomenclature to utilize for a proper functioning clinical decision support rule.

In one or more embodiments, a clinical decision support rule can include if/then logic so that one or more actions can be executed upon identifying one or more patients that satisfy a portion of the clinical decision support rule. For example, in one embodiment, a clinical decision support rule can include a list of a plurality of actions to be executed when one or more patients have been identified as having satisfied at least a portion of a clinical decision support rule, e.g., one or more patients have been identified as having been ordered a specific medication within the last two weeks. In this example, the clinical decision support rule may execute any number of actions, such as, provide an alert to a healthcare provider, generate a worklist of the identified patients, and/or provide a reminder to the healthcare provider to check in with the identified patients or remove the identified patients from a present list and/or workflow. In one embodiment, the clinical decision support rule can be utilized to stop a healthcare provider in their workflow, e.g., by alerting the healthcare provider that a prescribed dose of a medication is out of range. Additionally or alternatively, the clinical decision support rule may execute more complex actions, such as using one or more algorithms on the identified patients to identify if such patients are at risk for a disease and/or a medical treatment complication. As discussed further below, one or more components of the clinical decision support rule server 220 can be utilized to take such actions. In embodiments, like the pre-defined options discussed above with reference to the pre-defined parameters and the rule segment options, these plurality of actions to be executed when one or more patients have been identified as having satisfied at least a portion of a clinical decision support rule can be provided to the healthcare provider in the form of a list of pre-defined action options, e.g., by the rule generation component 224. In such embodiments, this list of pre-defined action options can facilitate the efficient creation of a clinical decision support rule by a healthcare provider without requiring the assistance of an IT specialist or a specialist associated with particular medical records and/or health information system.

In one or more embodiments where the healthcare provider wishes to not use a pre-defined option for a rule segment option or a pre-defined action option, the rule generation component 224 can provide the healthcare provider an opportunity to create any parameter, rule segment, or action, when creating a clinical decision support rule in order to allow for complete customization of a clinical decision support rule. In such embodiments, the clinical decision support rule server 220 may validate such customized portion of the clinical decision support rule so that such a rule can be executed correctly in an EMR database, e.g., by verifying that such parameters of a rule correspond to discretely captured and searchable data available in one or more EMRs.

In embodiments, the rule generation component 224 can provide the healthcare provider the opportunity to assign a severity score to a particular clinical decision support rule being created. In such embodiments, a severity score can provide a mechanism for the healthcare provider to flag the importance of that particular clinical decision support rule being generated, which may be useful later on when the healthcare provider is reviewing the output of one or more executed clinical decision support rules. In one embodiment, the severity score can be a numerical value, e.g., a value from 0-100. In certain embodiments, the severity score can be associated with one or more terms, e.g., mild, moderate, or severe. As an example, in one embodiment, where a healthcare provider is reviewing information associated with patients that may be seen on a particular day, a flag or notation that a patient has satisfied a clinical decision support rule classified as severe may prompt the healthcare provider to take immediate action with respect to such a patient, or to prioritize care for such a patient.

In one or more embodiments, severity scores from more than one clinical decision support rule may be added together to form a combined severity score, if a particular patient satisfies these clinical decision support rules. In embodiments, a combined severity score can include the addition of any numerical severity scores for any clinical decision support rules that a particular patient has satisfied. In one or more embodiments where a patient has satisfied clinical decision support rules that are associated with a numerical severity score and some that are associated with a severity score term, e.g., mild, moderate, or severe, the term can be converted to a numerical severity score, or the numerical severity score can be converted a term, in order to arrive at a combined severity score. For example, in one embodiment, a mild severity may be converted to or associated with a severity score of up to 30, while a moderate severity may be converted to or associated with a severity score of 31 to 60, and a severe severity may be converted to a severity score of 61-90, or any number above 90. In such an example, a patient that has satisfied a moderate severity clinical decision support rule and a severe severity clinical decision support rule may be given a combined severity score of 150 (60 plus 90). In another embodiment, a patient having satisfied one clinical decision support rule with a severity score of 30 and one clinical decision support rule having a severity score of 90 may be given a severity score of severe. One skilled in the art will appreciate that several variations for obtaining a combined severity score or converting severity scores to be combined into a combined severity score may be utilized in the present disclosure.

In various embodiments, the rule generation component 224 can be configured to add to one or more EMRs one or more severity scores or combined severity scores associated with a patient.

In certain embodiments, the rule generation component 224 can be configured to convert rule segment options selected by a healthcare provider into a clinical decision support rule. In one or more embodiments, converting the selected rule segment options into a clinical decision support rule can include assembling the selected rule segments options into the final clinical decision support rule. In such embodiments, assembling the selected rule segment options into the final clinical decision support rule can include assembling and/or organizing all levels and orders of the selected rule segment options into the final single clinical decision support rule.

In certain embodiments, converting the selected rule segment options into a clinical decision support rule can include converting the selected rule segment options into a clinical decision support rule that can be executable within a database of EMRs, such as the database 218, and/or within one or more EMRs, such as the EMRs 212. For example, in one or more embodiments, if necessary, the rule generation component 224 may convert the clinical decision support rule into a form that can be used to search a database, such as the EMR database 218, and/or one or more EMRs. In embodiments, converting selected rule segment options into a clinical decision support rule can occur once the rule generation component 224 or another other component of the clinical decision support rule server 220 has received an indication from the healthcare provider that the healthcare provider has completed selecting the rule segment options for inclusion in the clinical decision support rule, e.g., by clicking a “Finish” button on a user interface.

In embodiments, the rule generation component 224 can provide a healthcare provider an opportunity to select a database of EMRs and/or one or more EMRs to execute the clinical decision support rule in. For example, in such embodiments, the rule generation component 224 can provide a list of healthcare facilities, which may represent a particular database of EMRs or a collection of EMRs to execute the clinical decision support rule in.

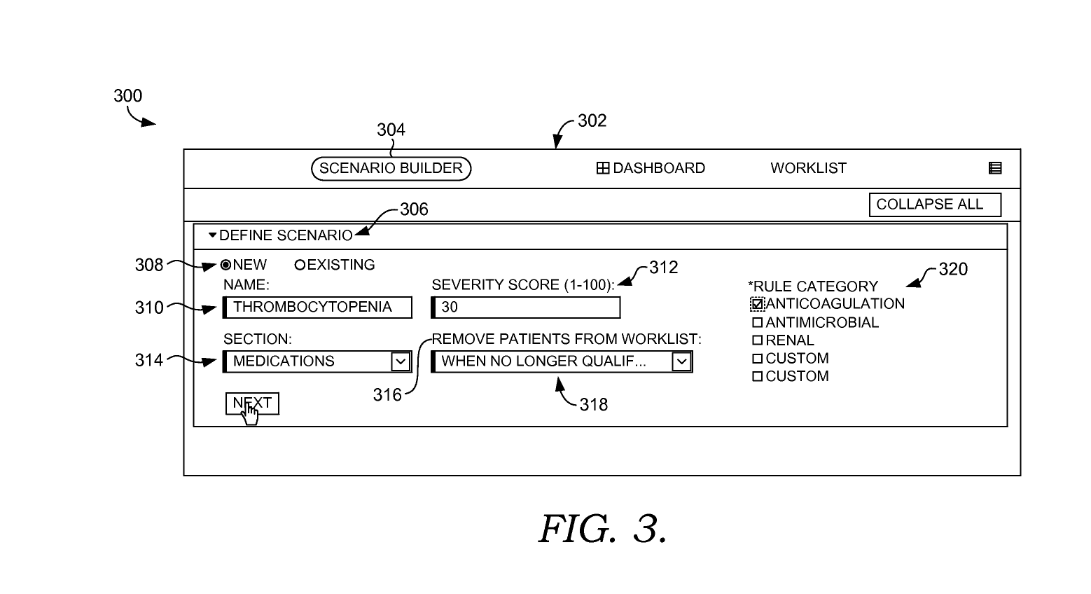

Exemplary user interfaces for creating and modifying a clinical decision support rule, which, in embodiments, may include information provided at least partially by the rule generation component 224, are depicted in FIGS. 3-7 and discussed below.

In embodiments, the rule modification component 226 can be configured to modify one or more existing clinical decision support rules. In one or more embodiments, the rule modification component 226 can provide the opportunity for a healthcare provider to select one or more existing clinical decision support rules for modification. In one embodiment, the rule modification component 226 can provide a search function for a healthcare provider to locate an existing clinical decision support rule for modification. In the same or alternative embodiments, the rule modification component 226 can provide a list of existing clinical decision support rules for selection by a healthcare provider.

In one or more embodiments, upon receiving from the healthcare provider a selection of an existing clinical decision support rule for modification, the rule modification component 226 can facilitate the modification of that existing clinical decision support rule by the healthcare provider, e.g., by providing the healthcare provider the opportunity to modify and/or delete any portion of the existing clinical decision support rule. Further, in such embodiments, the rule modification component 226 can provide a plurality of rule segment options or pre-defined actions for any or all portions of the existing clinical decision support rule that is being modified. In one embodiment, the rule modification component 226 can provide any or all of the rule segment options, pre-defined parameters, and pre-defined actions in a manner similar to that discussed above with reference to the rule generation component 224.

In certain embodiments, the accessing component 228 can be configured to access one or more databases containing EMRs, e.g., the EMR database 218, and/or can be configured to directly access one or more EMRs, e.g., the EMRs 212. In such embodiments, the accessing component 228 can access a database containing EMRs and/or directly access one or more EMRs via the network 210. In certain embodiments, the accessing component 228 can access one or more indexes associated with one or more EMRs and/or one or more EMR databases.

In embodiments, the execution component 230 can be configured to execute one or more clinical decision support rules in one or more EMR databases and/or in one or more EMRs, e.g., the one or more EMRs 212 (EMRs) associated with an EMR database 218. In one or more embodiments, executing a clinical decision support rule can include polling and/or monitoring one or more EMR databases and/or one or more EMRs to identify one or more patients that satisfy the clinical decision support rule. In such embodiments, polling an EMR database or one or more EMRs can include identifying patients that satisfy the clinical decision support rule at the time the clinical decision support rule is initially executed, or for a specified time period that has already occurred, e.g., in the 24 hours preceding the initial execution of the clinical decision support rule. In certain embodiments, monitoring an EMR database or one or more EMRs can include monitoring the EMR database or one or more EMRs to determine if one or more patients satisfy the clinical decision support rule over a period of time that extends at least subsequent to the time the clinical decision support rule was initially executed. In such embodiments, the period of time that extends subsequent to the time the clinical decision support rule was initially executed may be determined by the healthcare provider when creating and/or modifying the clinical decision support rule.

In embodiments, a clinical decision support rule may be executed in one or more EMR databases or in one or more EMRs within less than 24 hours, 12 hours, 8 hours, 4 hours, 1 hour, 30 minutes, 15 minutes, 5 minute, or 1 minute of when the clinical decision support rule was finalized by the healthcare provider. In such embodiments, a finalized clinical decision support rule refers to a clinical decision support rule that has been completed by a healthcare provider and where a healthcare provider has instructed the clinical rule server 220, e.g., the execution component 230 and/or the rule generation component 224, to execute the completed clinical decision support rule.

In embodiments, the worklist component 232 can be configured to provide a worklist to a computing device associated with the healthcare provider. In one or more embodiments, the worklist can include information associated with the patients that satisfy one or more clinical decision support rules. In such embodiments, the worklist component 232 and other components of the clinical decision support rule server 220 can allow a healthcare provider to efficiently identify a population or group of patients that satisfy one or more clinical decision support rules. In this manner, the clinical decision support server 220 and its components can provide a user-friendly process for a healthcare provider to search EMRs by creating and using a clinical decision support rule and populate a worklist (e.g., by identifying one or more patients that satisfy that clinical decision support rule) without having to involve information technology specialists or an administrator of a healthcare information system of which one or more EMRs may be associated.

In embodiments, the worklist component 232 can provide a worklist for at least a portion of the patients within a population of patients that satisfy one or more clinical decision support rules. In the same or alternative embodiments, the worklist component 232 can provide a worklist for at least a portion of patients within a population of patients having a specific combined severity score, due to being identified as satisfying one or more clinical decision support rules. In such embodiments, a worklist may include a patient's names, severity scores, location, clinical issues and alerts, care planning, payer information, healthcare provider information, demographics, medication information, and/or appointments.

In embodiments, in addition to providing a list of patients that satisfy one or more clinical decision support rules or exhibit a specific severity score, the worklist can include functionality to facilitate care for one or more patients in the worklist. For example, in certain embodiments, the worklist can enable the healthcare provider to determine: if an appointment was set; if a call to the patient is needed, if help scheduling an appointment is needed; if help getting a prescription filled is needed; and/or if a prescription was not filled. In embodiments, a worklist may also enable one or more healthcare providers to send out group communications or announcements, receive alerts, and/or review such announcements, communications, and alerts.

In one or more embodiments, a worklist can be configured to provide access to all or substantially all information contained in one or more EMRs of the patients in a worklist. In one embodiment, all or substantially all information contained in one or more EMRs may refer any electronic healthcare documents which a healthcare provider may need to manage and/or treat patients.

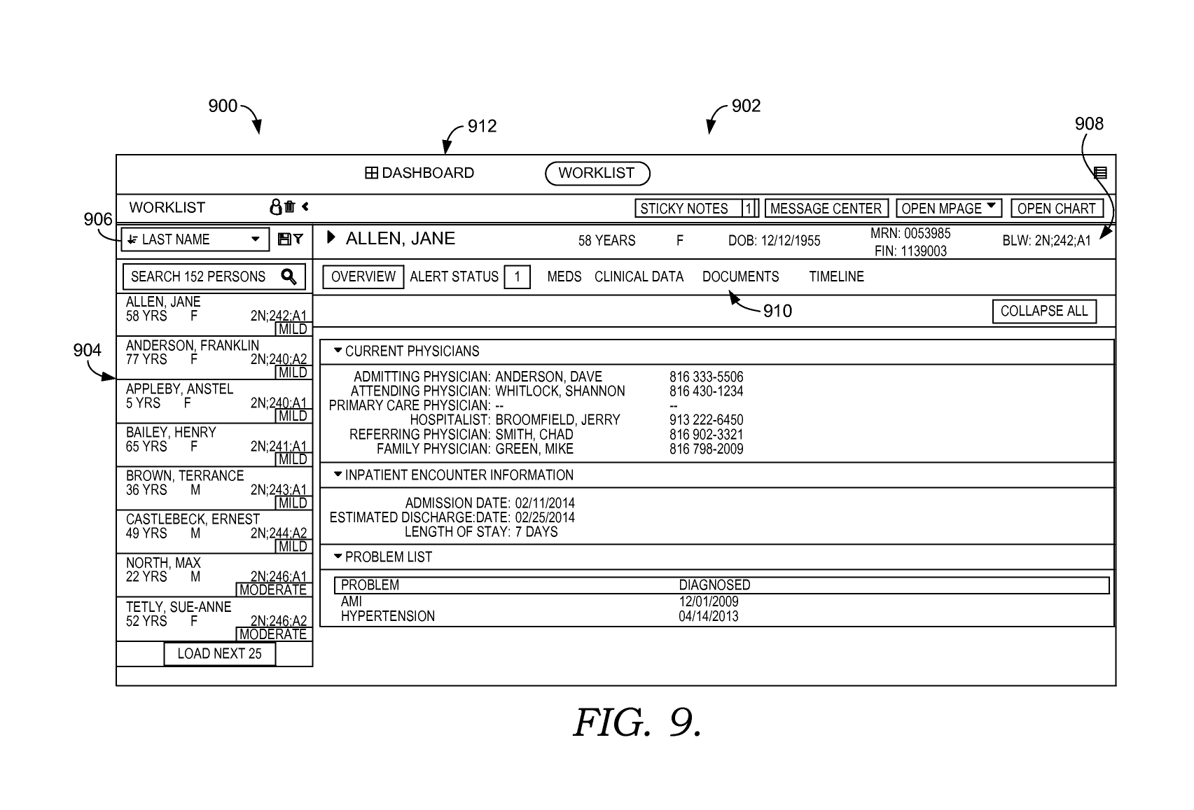

In certain embodiments, the worklist may comprise rows of patient names, tabs to represent a variety of EMR categories or topics, and/or filtering capability to allow for individual use preferences. In such embodiments, examples of tabs (which may be customized by the healthcare provider/healthcare facility) may include patient overview information, alert status, medications, clinical data, documents, and/or a timeline view. An exemplary worklist, which, in embodiments, may be at least partially created by the worklist component 232, is depicted in FIG. 9 and discussed below.

In embodiments, the alert component 234 can be configured to provide alerts based on the identification of patients that satisfy one or more clinical decision support rules. As discussed above, the clinical decision support rules can be executed, e.g., via the execution component 230, to poll and/or to monitor one or more EMRs or a database containing EMRs to identify one or more patients that satisfy the executed clinical decision support rule. In such embodiments, the alert component 234 can provide an alert and/or a notification to one or more healthcare providers that one or more patients have already satisfied the executed clinical decision support rule. In the same or alternative embodiments, the alert component 234 can provide an alert and/or a notification to one or more healthcare providers when one or more patients satisfy the executed clinical decision support rule over a time period subsequent to the execution of the clinical decision support rule. In such embodiments, therefore, the alert component 234 may alert and/or notify one or more healthcare providers when one or more patients satisfy the clinical decision support rule at some point in the future after the clinical decision support rule has been executed. In embodiments, the healthcare provider that designs and/or modifies the clinical decision support rule can decide which healthcare providers and/or healthcare facilities receive the alerts or notifications associated with that particular clinical decision support rule.

In embodiments, the alert component 234 can be configured to provide alerts to pagers, fax machines, email accounts, or in any portion of a healthcare facilities health information system, e.g., provide alerts while a healthcare provider is filling out an order. In such embodiments, the healthcare provider that designs and/or modifies the clinical decision support rule can decide how the notifications or alerts can be provided.

In certain embodiments, the dashboard component 236 can be configured to provide a healthcare provider an overview of all the patients satisfying one or more clinical decision support rules. In such embodiments, the dashboard component 236 can provide general information to a healthcare provider and/or healthcare facility, e.g., the numbers of patients that satisfy each of the active or executed clinical decision support rules, the number of patients within each severity score range, and/or the number of patients that satisfy one or clinical decision support rules organized by various medical services. As discussed above, in embodiments, when designing a clinical decision support rule, the healthcare provider can provide a severity score associated with that particular clinical decision support rule. In such embodiments, if a patient satisfies more than one clinical decision support rule, that patient's combined severity score may be the sum of the individual severity scores associated with the clinical decision support rules that that patient satisfies. Accordingly, the dashboard component 236, in embodiments, can provide the number of patients having various combined severity scores, e.g., mild, moderate, severe, or numerical scores as discussed above with reference to the rule generation component 224.

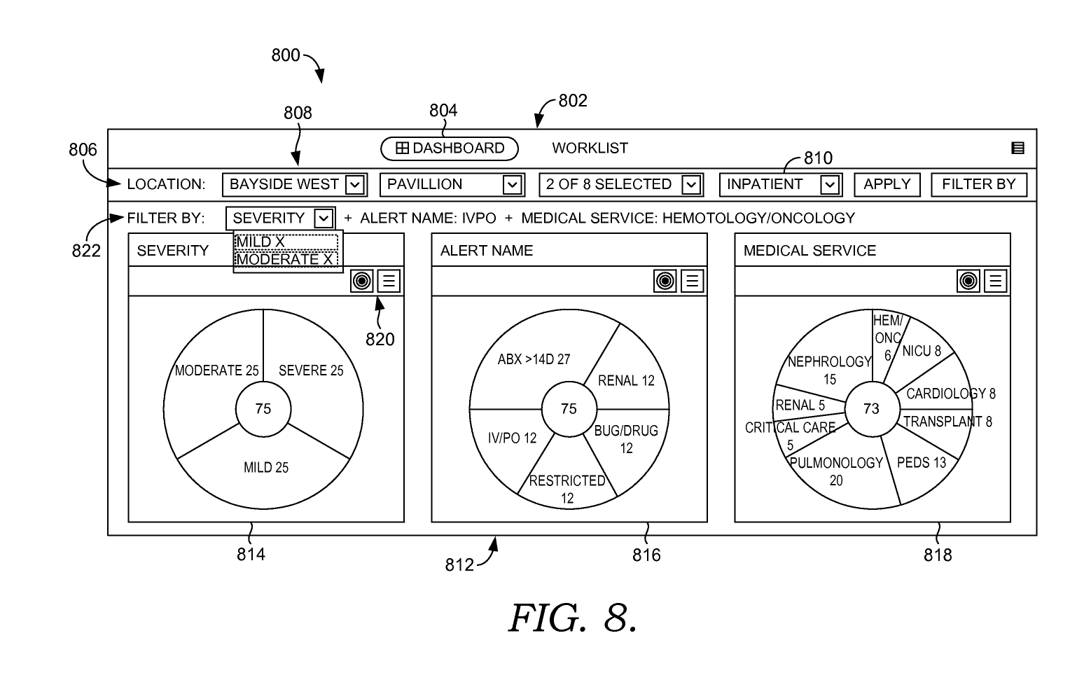

In certain embodiments, the dashboard component 236 can provide the healthcare provider the opportunity to filter or select patients satisfying all clinical decision support rules by facility and/or patient status, e.g., inpatient or outpatient, discharged, etc. An exemplary dashboard, which, in embodiments, may be at least partially created by the dashboard component 236, is depicted in FIG. 8 and discussed below.

In embodiments, the display component 238 can be configured to provide information for display on one or more computing devices associated with the healthcare provider, e.g., the workstation computing device 214 or the mobile computing device 216. For example, in such embodiments, the information for display on a computing device associated with the healthcare provider can include information provided by one or more components of the clinical decision support rule server 220, such as the rule generation component 224, the rule modification component 226, the execution component 230, the worklist component 232, the alert component 234, and/or the dashboard component 236.

FIGS. 3-7 depict exemplary interfaces that may be used to provide rule segment options and actions to a healthcare provider so that the healthcare provider can design at least a portion of a clinical decision support rule.

FIG. 3 depicts an exemplary user interface 300 that can be displayed on a computing device associated with a healthcare provider, e.g., the workstation computing device 214 or the mobile computing device 216. In embodiments, at least a portion information utilized to form the user interface 300 can be provided by one or more components of the clinical decision support rule server 220 of FIG. 2, such as the rule generation component 224, the rule modification component 226, and/or the execution component 230.

In embodiments, the user interface 300 can include interface viewing options 302 for building and/or modifying a clinical decision support rule, for displaying a dashboard overview, or for displaying a worklist. In the embodiment depicted in FIG. 3, the scenario builder 304 for building and/or modifying a clinical decision support rule has been selected. The user interface 300 may include a define scenario interface 306 where a healthcare provider can generate and/or modify a clinical decision support rule.

In embodiments, the define scenario interface 306 can include a selector 308 for selecting between the building a new clinical decision support rule or modifying an existing one. In an embodiment not depicted in the figures, when a healthcare provider selects to modify an existing clinical decision support rule a user interface may provide for selection a list of existing clinical decision support rules for a healthcare provider to modify. In such embodiments, upon selecting a clinical decision support rule to modify, all fields in the user interface, e.g., the interface 300, may be populated with any or all existing information previously selected in the creation of that existing clinical decision support rule.

Further, the define scenario interface 306 may include fields 310 and 312 for the healthcare provider to provide a name and a severity score, respectively, for the clinical decision support rule being generated. The define scenario interface 306 may also include a section selector 314, which may include a drop down list for the healthcare provider to select a section for which this portion of the clinical decision support rule being generated belongs. In such embodiments, a drop down list of sections may include, but is not limited to, medications, labs, microbiology, other orders, patient demographics, and/or vitals.

In certain embodiments, the define scenario interface 306 can include an action section 318 where the healthcare provider can select a predefined action to occur when at least a portion of the clinical decision support rule being has been satisfied. In this exemplary embodiment of FIG. 3, the action selection 318 includes the action 316: removing patients from the worklist, and provides further options for selection detailing when to remove the patients.

In certain embodiments, the define scenario interface 306 can include a rule category selector 320 for the healthcare provider to select a rule category for the clinical decision support rule being generated. As discussed above with reference to the rule generation component 224 of FIG. 2, the rule category can be utilized to categorize the rule being developed so that the healthcare provider may select specific healthcare providers and/or facilities for receiving information associated with the rule being developed and/or to provide for easy navigation of the pre-defined parameters and/or pre-defined action options when creating the clinical decision support rule.

In an embodiment not depicted in FIG. 3, a define scenario interface, e.g., the define scenario interface 306, may include pre-defined options to allow a healthcare provider to select which EMRs or EMR database to execute the clinical decision support rule in. In the same or alternative embodiments, and not depicted in FIG. 3, a define scenario interface, e.g., the define scenario interface 306, may include pre-defined options to allow a healthcare provider to select which healthcare facilities and/or which healthcare providers should receive information generated by the clinical decision support rule, e.g., alerts, notifications, worklists, and/or dashboard views.

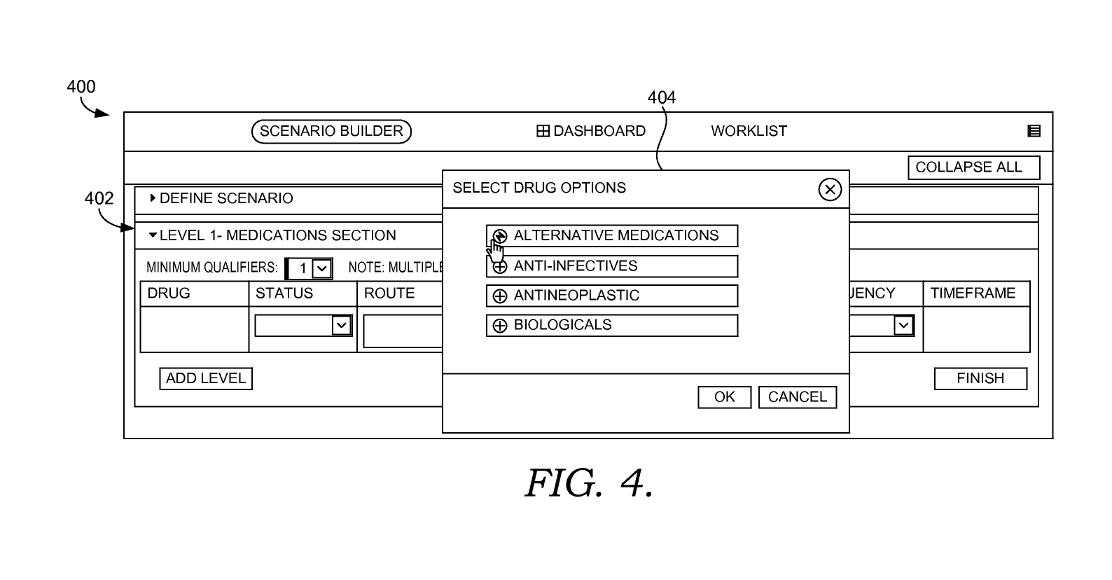

FIG. 4 depicts a user interface 400 that can be displayed when a healthcare provider has selected to create a clinical decision support rule that includes a medication portion or section 402. In this exemplary interface 400, a pop-up window 404 is shown providing a list of pre-defined drug options for the healthcare provider to select. In such embodiments, the selection of a pre-defined drug option can facilitate the further definition and/or selection of rule segment options. For example, by selecting a pre-defined drug option the system, e.g., the clinical decision support rule generation and maintenance system 200 of FIG. 2, can provide further rule segment options tailored to that selected pre-defined drug option.

FIG. 5 depicts a user interface 500 that can be displayed when a healthcare provider has selected to create a clinical decision support rule that includes a medication portion or section 502. In the user interface 500, the healthcare provider has designed two alternative medication rule segments 504 and 506.

In operation, in certain embodiments, the healthcare provider may first select one or more medications from a pre-defined list of potential drug options. Then, in such embodiments, the healthcare provider can select one or more parameters for that selected medication or medications, e.g., status of the medication, delivery route, dosage amount, dosage from, frequency and/or time frame. In one or more embodiments, one or all of such parameters may be pre-defined and available as rule segment options in drop down menus or another format.

As discussed above, in the embodiment depicted in FIG. 5, two alternative medication rule segments 504 and 506 have been designed by a healthcare provider. The medication rule segment 504 of FIG. 5 includes three alternative medications, with a status of ordered, that are to be administered in one of four different routes. The medication rule segment 506 of FIG. 6 includes one medication, with a status of ordered, that is to be administered in one of four different routes. The user interface 500 also includes instructions 508 for the healthcare provider for designing the medication section 502 of the clinical decision support rule being designed. In embodiments, such as that depicted in FIG. 5, the instructions 508 can provide user-friendly guidance on how to apply Boolean operators (e.g., OR, AND, AND NOT, etc.) in the user interface 500 when designing the rule segments. For instance, as indicated in the instructions 508 of FIG. 5, multiple items in columns have OR logic, and thus in the medication segment 504, the selection of 3 different medications may denote that this medication segment of the clinical decision support rule denotes that rifampicin, vancomycin, or linezolid are acceptable for determining whether this medication rule segment 504 can be satisfied. In addition, as indicated in the instructions 508 of FIG. 5, the two separate medication rule segments 504 and 506 are in separate rows, and thus, satisfying either one of the medication rule segments 504 or 506 will satisfy the medication level 502 of the clinical decision support rule being designed.

In embodiments, the user interface 500 can also include a button/link 516 for indicated that the healthcare provider has finished designing the clinical decision support rule, a button/link 510 to add another row to the medication section, or a button/link 512 to add another level to the clinical decision support rule. In embodiments, where the healthcare provider wishes to add another level and interacts with the button 512, a list 514 may appear so that the healthcare provider can chose what pre-defined section is to be associated with this newly selected level.

FIG. 6 depicts a user interface 600 that can be displayed when a healthcare provider has selected to create a clinical decision support rule that includes a medication portion level 602 and a clinical laboratory level 604. As indicated by the instructions 616, different levels, e.g., the medication level 602 and the clinical laboratory level 604, can include AND or AND NOT operators. Accordingly, when a healthcare provider is adding a level, e.g., the clinical laboratory level 604, in addition to another level, e.g., the medication level 602, the user interface 600 can include a Boolean operator option selector 618 for the healthcare provider to select whether the additional level, is to be required to satisfy the clinical decision support rule or must not be present in order to satisfy the clinical decision support rule.

As discussed above, the user interface 600 indicates that a healthcare provider has selected to create a clinical laboratory level or portion 604 in the clinical decision support rule. In operation, in embodiments, a plurality of pre-defined clinical laboratory orders can be provided to the healthcare provider for selection. In such embodiments, once the healthcare provider selects a pre-defined clinical laboratory order, a plurality of parameters 608 may be inputted and/or selected by the healthcare provider from pre-defined parameter options, e.g., rule segment options, for each of the parameters 608. Once the healthcare provider has finished designing the clinical laboratory level or portion 604 of the clinical decision support rule, the healthcare provider can select one of the buttons/links 610, 612, or 614 to add a level, a row, or finish creating the clinical decision support rule, respectively.

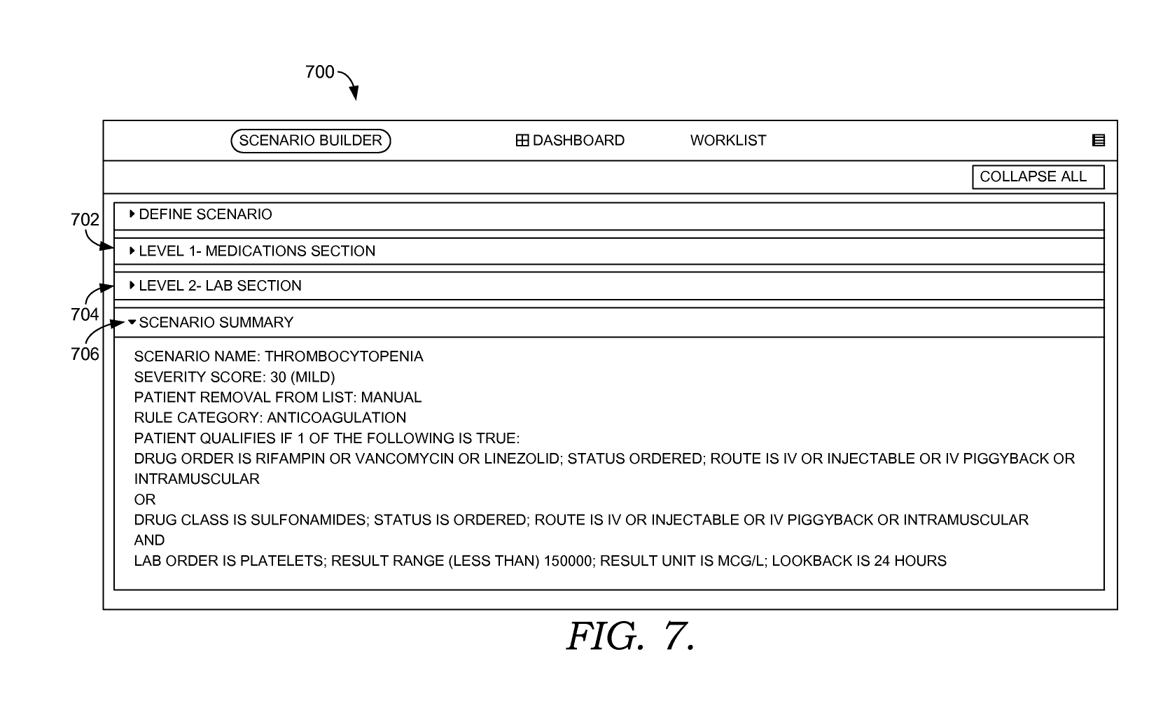

FIG. 7 depicts a user interface 700 that can be displayed when the healthcare provider has indicated the completion of designing the clinical decision support rule, e.g., by selecting the finish button/link 614 of FIG. 6. The user interface 700 can indicate the levels, e.g., 702 and 704, that define at least a portion of the clinical decision support rule. In embodiments, the user interface 700 can include a summary 706 of the clinical decision support rule designed by the healthcare provider to provide the healthcare provider an opportunity to review the completed rule. In such embodiments, if the healthcare provider wishes to modify the clinical decision support rule, the healthcare provider can select one of the levels or the “define scenario” tab to view the rule segments options previously selected to make any necessary changes. In an embodiment not depicted in FIG. 7, a user interface summarizing a completed clinical decision support rule can include a button/link to execute the clinical decision support rule in an EMR database or in one or more EMRs.

FIG. 8 depicts an exemplary interface 800 which can be displayed on a computing device associated with a healthcare provider. The interface 800 can include viewing options 802, such as a dashboard viewing option 804 and a worklist viewing option. In the embodiment depicted in FIG. 8, an embodiment of the dashboard view 804 is shown.

The dashboard view 804 can include a plurality of view tailoring options 806, such as a pre-defined list of healthcare facilities and/or locations 808 and other information from which the healthcare provider may choose to tailor the dashboard view 804. In the embodiment depicted in FIG. 8, the tailoring options allow a healthcare provider to select any or all of the healthcare locations associated with that healthcare provider, and in this embodiment, the healthcare provider selected 2 out of 8 locations. Further, in this embodiment, the view tailoring options 806 can provide an opportunity for the healthcare provider to tailor the dashboard view 804 based on the patient status in a drop down list 810 of pre-defined patient statuses. In operation once the healthcare provider has selected the view tailoring options 806 to apply, the dashboard view may provide a graphical view 812 of the patients within these view tailoring options that have satisfied one or more clinical decision support rules. In an embodiment not depicted in the figures, the dashboard may not require the healthcare provider to select view tailoring options, and instead the dashboard view may provide a representation of all the patients associated with the healthcare provider that satisfy any clinical decision support rules associated with that healthcare provider.

In the embodiment depicted in FIG. 8, the graphical view 812 can include one or more graphical views 814, 816, and/or 818, with each individual graphical view 814, 816, and 818 depicting the number of patients that satisfy one or more clinical support rules in various categories, such as composite severity score (814), alert name (816), or medical service (818). For example, in the severity level graphical view 814, there are 25 patients that have a severity level of severe, while in the alert name graphical view 816 there are 12 patients that have an alert associated with the renal clinical decision support rule, and there are 20 patients receiving pulmonology care that have satisfied the clinical decision support rules at the selected healthcare facilities or locations. In embodiments, the graphical views 814, 816, and/or 818 may include alternative viewing options 820 to depict the number of patients that satisfy one or more clinical support rules, such as by depicting such patients in lists.

In various embodiments, the dashboard view may provide filtering options 822 so that a healthcare provider may filter the patients within this dashboard view 804 to create a worklist. For example, in the embodiment depicted in FIG. 8, a healthcare provider may filter the patients represented in this dashboard view 804 by severity level, alert name, and/or by a medical service to generate a worklist. To facilitate the filtering of the patients represented in this dashboard view 804, a healthcare provider may select options from a pre-defined list to generate the worklist. In an embodiment not depicted in the figures, a worklist may be automatically generated in response to the execution of one or more clinical decision support rules.

FIG. 9 depicts a user interface 900 illustrating a worklist 902. The worklist 902 of FIG. 2 may include a list 904 of all patients satisfying one or more clinical decision support rules, or the list 904 may include a list of all patients that were filtered from a dashboard view, as discussed above with reference to FIG. 8. The worklist 902 may provide a search function 906 for a healthcare provider to search the data associated with the worklist 902. In embodiments, the worklist 902 may also include a patient view area 908 so that when a healthcare provider selects a particular patient from the list 904, the healthcare provider can see information associated with that particular patient. In one or more embodiments, the worklist 902 may provide access to all or substantially all of the patient information in one or more EMRs. For example, in the embodiment depicted in FIG. 9, the patient view area 908 may include links 910 to direct the healthcare provider to information contained in a patient's EMR. In certain embodiments, the user interface 900 can include viewing options 912 so that the healthcare provider can select a dashboard view, where the healthcare provider may generate a new worklist to view.

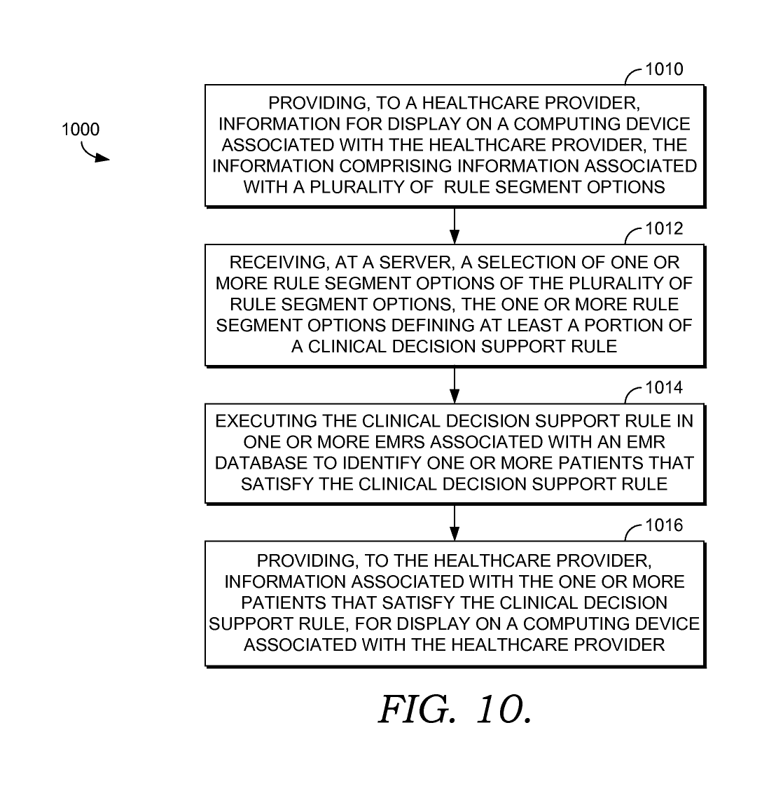

FIG. 10 depicts an exemplary flow diagram for a method 1000 that facilitates the creation and maintenance of one or more clinical decision support rules by a healthcare provider. At step 1010, information for display on a computing device associated with the healthcare provider can be provided to a healthcare provider. The information may include information associated with a plurality of rule segment options, where the plurality of rule segment options include a plurality of pre-defined parameters for use in the creation of one or more clinical decision support rules. In certain embodiments, the step 1010 can be performed at least partly by the rule generation component 224 and the display component 238 discussed above with reference to FIG. 2. The rule segment options and/or the pre-defined parameters can have any or all of the properties discussed above with reference to the clinical decision support rule server 220 of FIG. 2. In certain embodiments, the computing device associated with the healthcare provider can include one or more of the workstation computing device or the mobile computing device discussed above with reference to FIG. 2. At step 1012, a selection of one or more rule segment options of the plurality of rule segment options can be received, where the selected rule segment options can define at least a portion of a clinical decision support rule. In one embodiment, the selection of one or more rule segment options can be performed by a healthcare provider and the selection of the one or more rule segment options can be received at one or more components of a server, such as the rule generation component 224 of the clinical decision support rule server 220 discussed above with reference to FIG. 2. At step 1014 the clinical decision support rule can be executed in one or more EMRs associated with an EMR database to identify one or more patients that satisfy the clinical decision support rule. In embodiments, the step 1014 can be at least partly performed by the execution component 230 of the clinical decision support rule server 220 discussed above with reference to FIG. 2. In embodiments, the EMR database may include any or all of the parameters as the EMR database 218 discussed above with reference to FIG. 2. At step 1016, information associated with the one or more patients that satisfy the clinical decision support rule can be provided to the healthcare provider, for display on a computing device associated with the healthcare provider. In embodiments, the step 1016 can be at least partly performed by the display component 238 of the clinical decision support rule server 220 discussed above with reference to FIG. 2.

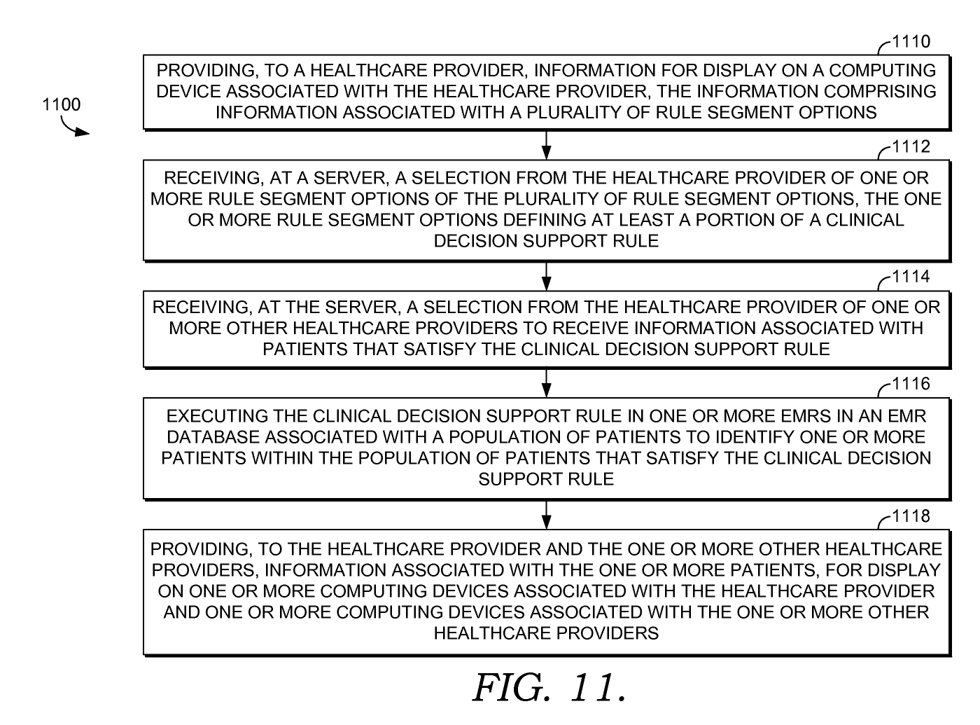

FIG. 11 depicts an exemplary flow diagram for a method 1100 that facilitates the creation and maintenance of one or more clinical decision support rules by a healthcare provider. At step 1110 information for display on a computing device associated with the healthcare provider can be provided to a healthcare provider. The information may include information associated with a plurality of rule segment options, where the plurality of rule segment options include a plurality of pre-defined parameters for use in the creation of one or more clinical decision support rules. In certain embodiments, the step 1110 can be performed at least partly by the rule generation component 224 and the display component 238 discussed above with reference to FIG. 2. The rule segment options and/or the pre-defined parameters can have any or all of the properties of the rule segment options and/or the pre-defined parameters discussed above with reference to the clinical decision support rule server 220 of FIG. 2. In certain embodiments, the computing device associated with the healthcare provider can include one or more of the workstation computing device 214 or the mobile computing device 216 discussed above with reference to FIG. 2. At step 1112, a selection from the healthcare provider of one or more rule segment options of the plurality of rule segment options can be received, where the selected rule segment options can define at least a portion of a clinical decision support rule. In one embodiment, the selection of the one or more rule segment options can be received at a server, such as the clinical decision support rule server 220 or at one or more components thereof discussed above with reference to FIG. 2. At step 1114, a selection from the healthcare provider of one or more other healthcare providers to receive information associated with patients that satisfy the clinical decision support rule can be received at a server, e.g., the clinical decision support rule server 220 or at one or more components thereof discussed above with reference to FIG. 2. At step 1116, the clinical decision support rule can be executed in one or more EMRs in an EMR database associated with a population of patients to identify one or more patients within the population of patients that satisfy the clinical decision support rule. In certain embodiments, the execution component 230 discussed above with reference to FIG. 2 may be utilized to execute the clinical decision support rule in the one or more EMRs in the EMR database associated with a population of patients. In embodiments, the one or more EMRS in an EMR database can have any or all of the properties as the EMRs 212 and the EMR database 218, respectively, discussed above with reference to FIG. 2. At step 1118, information associated with the one or more patients can be provided to the healthcare provider and the one or more other healthcare providers, for display on one or more computing devices associated with the healthcare provider and one or more computing devices associated with the one or more other healthcare providers. In embodiments, the step 1118 can be at least partly performed by the display component 238 of the clinical decision support rule server 220 discussed above with reference to FIG. 2. In certain embodiments, the one or more computing devices associated with the healthcare provider and one or more computing devices associated with the one or more other healthcare providers can include one or more of the workstation computing device 214 or the mobile computing device 216 discussed above with reference to FIG. 2.

The present invention has been described in relation to particular embodiments, which are intended in all respects to be illustrative rather than restrictive. Further, the present invention is not limited to these embodiments, but variations and modifications may be made without departing from the scope of the present invention.

Having thus described the invention, what is claimed is:

1. One or more computer storage media storing computer-executable instructions that, when executed by one or more computing devices, cause the one or more computing devices to perform a method that facilitates the creation and maintenance of one or more clinical decision support rules by a healthcare provider, the method comprising:
providing, to a healthcare provider, information for display on a computing device associated with the healthcare provider, the information comprising information associated with a plurality of rule segment options, the plurality of rule segment options comprising a plurality of pre-defined parameters for use in the creation of one or more clinical decision support rules;
receiving, at a server, a selection of one or more rule segment options of the plurality of rule segment options, the one or more rule segment options defining at least a portion of a clinical decision support rule;
executing the clinical decision support rule in one or more EMRs associated with an EMR database to identify one or more patients that satisfy at least a portion of the clinical decision support rule; and
providing, to the healthcare provider, information associated with the one or more patients that satisfy the clinical decision support rule, for display on a computing device associated with the healthcare provider.

2. The media of claim 1, wherein the plurality of pre-defined parameters comprise one or more of medical treatments, treatment status, clinical laboratory tests, results or ranges for clinical laboratory tests, time periods, or Boolean operators.

3. The media of claim 1, wherein the information for display comprises an alert or notification for the healthcare provider that at least one patient of the one or more patients has satisfied at least a portion of the clinical decision support rule.

4. The media of claim 1, wherein the wherein the information for display comprises a worklist, the worklist including a list of the one or more patients that satisfy at least a portion of the clinical decision support rule.

5. The media of claim 4, wherein the worklist is configured to provide to the healthcare provider access to all or substantially all information contained in an EMR for each patient of the list of the one or more patients.

6. The media of claim 1, wherein the one or more EMRs in the EMR database are selected by the healthcare provider for execution of the clinical decision support rule.

7. The media of claim 1, wherein the method further comprises receiving, from the healthcare provider, a severity score associated with the clinical decision support rule, wherein, at least a portion of an EMR of each of the one or more patients identified as satisfying the clinical decision support rule comprises information associated with the severity score.

8. The media of claim 1, wherein the method further comprises providing the healthcare provider an opportunity to modify the clinical decision support rule after the clinical decision support rule has been executed in the one or more EMRs in the EMR database.

9. A computer system that facilitates the creation and maintenance of one or more clinical decision support rules by a healthcare provider, the computer system comprising a processor coupled to a computer storage medium, the computer storage medium having stored thereon a plurality of computer software components executable by the processor, the computer software components comprising:
a rule generation component configured to provide to a healthcare provider a plurality of rule segment options, the plurality of rule segment options comprising pre-defined parameters for use in the creation of at least one clinical decision support rule;
an accessing component configured to access one or more EMRs in a database of EMRs associated with a population of patients;
an execution component configured to execute the at least one clinical decision support rule in the one or more EMRs in a database of EMRs associated with a population of patients and configured to identify one or more patients within the population of patients that satisfy at least a portion of the at least one clinical decision support rule; and
a display component configured to provide to the healthcare provider information for display on a computing device associated with the healthcare provider, the information for display comprising information associated with the one or more patients within the population of patients that satisfy the at least a portion of the at least one clinical decision support rule.

10. The computer system of claim 9, further comprising a worklist component configured to generate a worklist based on the identification of the one or more patients within the population of patients as having satisfied the at least a portion of the at least one clinical decision support rule, wherein the worklist is configured to provide access to the healthcare provider of all or substantially all of the information associated with an EMR of each of the one or more patients within the population of patients that satisfy the at least a portion of the at least one clinical decision support rule.

11. The computer system of claim 9, wherein the information associated with the one or more patients within the population of patients that satisfy the at least a portion of the at least one clinical decision support rule comprises an alert or notification.

12. The computer system of claim 9, wherein the rule generation component is configured to provide the healthcare provider the opportunity to select only specific healthcare providers and/or only specific healthcare facilities to receive the information for display associated with the one or more patients within the population of patients that satisfy the at least a portion of the at least one clinical decision support rule.

13. The computer system of claim 9, wherein the pre-defined parameters comprise one or more of medical treatments, treatment status, clinical laboratory tests, results or ranges for clinical laboratory tests, time periods, or Boolean operators.

14. The computer system of claim 9, further comprising a rule modification component configured to provide the healthcare provider the opportunity to modify the at least one clinical decision support rule after the at least one clinical decision support rule has been executed in the one or more EMRs in a database of EMRs associated with a population of patients.

15. The computer system of claim 9, wherein the rule generation component is further configured to receive, from the healthcare provider, a severity score associated with the at least one clinical decision support rule.

16. A computer-implemented method being performed by one or more computing devices including at least one processor, for facilitating the creation and maintenance of one or more clinical decision support rules by a healthcare provider, the method comprising:
providing, to a healthcare provider, information for display on a computing device associated with the healthcare provider, the information comprising information associated with a plurality of rule segment options, the plurality of rule segment options comprising pre-defined parameters for use in the creation of one or more clinical decision support rules;
receiving, at a server, a selection from the healthcare provider of one or more rule segment options of the plurality of rule segment options, the one or more rule segment options defining at least a portion of a clinical decision support rule;
receiving, at the server, a selection from the healthcare provider of one or more other healthcare providers to receive information associated with patients that satisfy the clinical decision support rule;
executing the clinical decision support rule in one or more EMRs in a database of EMRs associated with a population of patients to identify one or more patients within the population of patients that satisfy at least a portion of the clinical decision support rule; and
providing, to the healthcare provider and the one or more other healthcare providers, information associated with the one or more patients, for display on one or more computing devices associated with the healthcare provider and one or more computing devices associated with the one or more other healthcare providers.

17. The method of claim 16, wherein the information associated with the one or more patients comprises a worklist, the worklist comprising a list of the one or more patients within the population of patients that satisfy the at least a portion of the clinical decision support rule, wherein the worklist is configured to provide to the healthcare provider and the one or more other healthcare providers access to all or substantially all information contained in an EMR for each patient of the list of the one or more patients.

18. The method of claim 16, wherein the information associated with the one or more patients comprises an alert or notification that the one or more patients within the population of patients satisfy the at least a portion of the clinical decision support rule.

19. The method of claim 16, wherein the pre-defined potential parameters comprise one or more of medical treatments, treatment status, clinical laboratory tests, results or ranges for clinical laboratory tests, time periods, or Boolean operators.

20. The method of claim 16, further comprising providing the healthcare provider an opportunity to modify the clinical decision support rule after the clinical decision support rule has been executed in the one or more EMRs associated with the population of patients in the database of EMRs.
